(19) United States
(12) Patent Application Publication
(10) Pub. No.: US 2022/0311796 A1
(43) Pub. Date: Sep. 29, 2022

(54) METHOD AND SYSTEM FOR ASSESSING RISK WITHIN A NETWORK

(71) Applicant: AXION PARTNERS LLC, Arlington, VA (US)

(72) Inventors: Jonathan DOYLE, Arlington, VA (US); Damon JACKMAN, Silver Spring, MD (US)

(73) Assignee: AXION PARTNERS LLC, Arlington, VA (US)

(21) Appl. No.: 17/703,298

(22) Filed: Mar. 24, 2022

Related U.S. Application Data
(60) Provisional application No. 63/165,232, filed on Mar. 24, 2021.

(51) Int. Cl. H04L 9/40

(52) U.S. Cl. CPC H04L 63/1433

(57) ABSTRACT

Systems, methods, and storage media for assessing risk within a network having a specified configuration, wherein the network includes hardware components and software components are disclosed. Exemplary implementations may identify a plurality of attack techniques to target the hardware components and the software components of the network; perform a first set of technical assessments from inside within the network; perform a second set of technical assessments from outside the network; determine a plurality of risk evaluations; determine a plurality of risk component scores; and determine an overall risk score using at least two risk component scores.

### CROSS-REFERENCE TO RELATED APPLICATIONS

The present disclosure claims the benefit of priority to provisional patent application No. 63/165,232 entitled “Method and System for Assessing risk within a network: filed on Mar. 24, 2021, the entirety of which is incorporated herein by reference.

### FIELD OF THE DISCLOSURE

The present disclosure relates to systems, methods, and storage media for assessing risk within a network having a specified configuration, wherein the network includes hardware components and software components. More particularly, the present disclosure relates to methods and system to evaluate the potential risk for a network for a cybersecurity attack or breach.

### BACKGROUND

Determination of appropriate risk to assign to a computer network is tricky. With regard to the cybersecurity insurance space, the following problems exist because risk is hard to determine. Traditionally, insurers use massive amounts of historical claims data to assess risk. Such data does not exist for cybersecurity claims. Insurers, instead, rely on that applicants self-disclose to do such risk evaluations. Further, insurers have very little ability to ensure that policyholders effectively protect their networks, which results in an increased risk of breach. Insurers are not able to provide risk reduction or minimization of losses. The amount of data an attack causes is largely determined by how long it takes to respond, and insurers do not know what is happening in real time, nor data to confirm that an exclusion applies.

The inability to assign or evaluate risk results in much confusion in the area of cybersecurity insurance. The area of cybersecurity insurance is growing. Cybersecurity insurance premiums currently are about $5,000,000,000 and growing about 25% annually. Businesses often buy insurance because they are required to do so as a part of a contract with a customer that wants to mitigate risk from third parties. Direct cost to businesses for breaches are significant. Regulated companies and those that handle personal information also want to mitigate risk. Moreover, businesses should accurately and adequately know where potential threats exist and how to reduce the risk of a cybersecurity breach or attack.

### SUMMARY

One aspect of the present disclosure relates to a system configured for assessing risk within a network having a specified configuration, wherein the network includes hardware components and software components. The system may include one or more hardware processors configured by machine-readable instructions. The processor(s) may be configured to identify a plurality of attack techniques to target the hardware components and the software components of the network. The processor(s) may be configured to perform a first set of technical assessments from inside within the network. Each technical assessment may evaluate at least one of the attack techniques as the technique internally applies to the specified configuration of the network. The processor(s) may be configured to perform a second set of technical assessments from outside the network. Each technical assessment may evaluate at least one of the attack techniques as the technique externally applies to the specified configuration of the network. The processor(s) may be configured to determine a plurality of risk evaluations. Each risk evaluation may evaluate a defined risk to the specified configuration of the network using a corresponding technical assessment. The processor(s) may be configured to determine a plurality of risk component scores. Each risk component scores may correspond to a component within the network using at least one risk evaluation of the plurality of risk evaluations. The processor(s) may be configured to determine an overall risk score using at least two risk component scores. Each of the risk component scores may be weighted according to the corresponding component.

Another aspect of the present disclosure relates to a method for assessing risk within a network having a specified configuration, wherein the network includes hardware components and software components. The method may include identifying a plurality of attack techniques to target the hardware components and the software components of the network. The method may include performing a first set of technical assessments from inside within the network. Each technical assessment may evaluate at least one of the attack techniques as the technique internally applies to the specified configuration of the network. The method may include performing a second set of technical assessments from outside the network. Each technical assessment may evaluate at least one of the attack techniques as the technique externally applies to the specified configuration of the network. The method may include determining a plurality of risk evaluations. Each risk evaluation may evaluate a defined risk to the specified configuration of the network using a corresponding technical assessment. The method may include determining a plurality of risk component scores. Each risk component scores may correspond to a component within the network using at least one risk evaluation of the plurality of risk evaluations. The method may include determining an overall risk score using at least two risk component scores. Each of the risk component scores may be weighted according to the corresponding component.

Yet another aspect of the present disclosure relates to a non-transient computer-readable storage medium having instructions embodied thereon, the instructions being executable by one or more processors to perform a method for assessing risk within a network having a specified configuration, wherein the network includes hardware components and software components. The method may include identifying a plurality of attack techniques to target the hardware components and the software components of the network. The method may include performing a first set of technical assessments from inside within the network. Each technical assessment may evaluate at least one of the attack techniques as the technique internally applies to the specified configuration of the network. The method may include performing a second set of technical assessments from outside the network. Each technical assessment may evaluate at least one of the attack techniques as the technique externally applies to the specified configuration of the network. The method may include determining a plurality of risk evaluations. Each risk evaluation may evaluate a defined risk to the specified configuration of the network using a corresponding technical assessment. The method may include determining a plurality of risk component scores. Each risk component scores may correspond to a component within the network using at least one risk evaluation of the plurality of risk evaluations. The method may include determining an overall risk score using at least two risk component scores. Each of the risk component scores may be weighted according to the corresponding component.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system to assess a network with a specified configuration according to the disclosed embodiments.

FIG. 2 illustrates a system configured for assessing risk within a network having a specified configuration, wherein the network includes hardware components and software components, in accordance with one or more disclosed embodiments.

FIG. 3A illustrates a method for assessing risk within a network having a specified configuration, wherein the network includes hardware components and software components, in accordance with one or more disclosed embodiments.

FIG. 3B further illustrates the method.

FIG. 3C further illustrates the method.

FIG. 3D further illustrates the method.

FIG. 3E further illustrates the method.

FIG. 4 illustrates an overview of the data flow within a system to generate an overall risk score for a network according to the disclosed embodiments.

FIG. 5 illustrates a flow diagram showing a combination of risk evaluations to generate an overall risk score according to the disclosed embodiments.

FIG. 6 illustrates a flow diagram for risk scoring for risks not evaluated according to the disclosed embodiments.

FIG. 7 illustrates a flow diagram of using additional sources of information for risk evaluation according to the disclosed embodiments.

### DETAILED DESCRIPTION

Reference will now be made in detail to specific embodiments of the present invention. Examples of these embodiments are illustrated in the accompanying drawings. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

As noted above, the usage of historical data of past claims typically does not apply to evaluation the risk of a cybersecurity attack. The insurance needs for such attacks are growing. The disclosed embodiments can reduce or eliminate the need for massive amounts of historical data. Cybersecurity threats to networks also change rapidly and sometimes the insurance industry cannot keep up with new or growing threats. These changes also drive price changes as new risks to a network are discovered. An effective analysis for a cybersecurity insurance policy also should deliver actual technical defenses against cybersecurity attacks.

The disclosed embodiments include a set of tools that are deployed outside and inside a network to determine what a company has within its network, the level of protection for the network, and items in place to prevent cybersecurity attacks. The analysis of these tools more accurately determines the risk to the network. In turn, a more accurate picture of potential threats to the network are determined. The disclosed embodiments use this information to provide a better insurance policy that addresses problems for the business and covers the business against actual threats as opposed to guess what might be exposed to attacks.

Challenges exist to provide an accurate insurance policy to a business. Most businesses may be required to obtain a policy, especially given the severity and embarrassment that accompanies a breach. Insurers cannot accurately price insurance premiums due to the lack of historical data normally used in determining premiums in other areas plus the cybersecurity threats are dynamic. The potential threat for a cybersecurity attack today is much different that those from 10 years ago. A policy issued today may not necessarily account for the potential threats even a year from now.

The disclosed embodiments replace the historical data with live data. The disclosed embodiments stream relevant data back to the insurance company to build a risk model. Vulnerabilities are determined and indicated as relevant. Technical assessment tools analyze attack techniques to decide what components to apply in the event of a cybersecurity attack. Tools may be used to cover multiple vulnerabilities.

An active customer overview includes on network technology that provides active defense to customers and data out to a security control server to implement the disclosed embodiments. Off network technology monitors what is exposed to the internet and can be used to determine risk before the customer buys a policy because nothing has to be installed. Data analysis according to the disclosed embodiments combines data from on network technology, off network technology, what the customer self-declares, and any other relevant data, such as a threat landscape. The risk score is generated based on automated data collection and automated analysis using proprietary algorithms and processes. The risk score with underlying data supports a recommendation provided in a digestible format to insurance underwriters. The risk score analysis also may be used in defensive technology development. The disclosed embodiments analyze data from customers to identify threats, pushes alerts for customers to take action, and updates the disclosed embodiments to offer improved defenses.

The disclosed processes to monitor and evaluate risk to a network also may be used in the lifecycle of the policy to insure the network from cybersecurity attacks. Risk may be mitigated and value delivered throughout the lifecycle of a policy, even in the event of an incident. Customer needs are captured. An offering to the customer is responsive to requirements. The risk assessment of the customer is a technical assessment that provides more insight than a self-assessment. The policy is issued and protections implemented. Technical protections are constantly updated to protect against emerging threats. When a technically mitigated incident occurs, the time to detection may be extremely short for known threats. When a non-technically mitigated incident occurs, the disclosed embodiments implement technology likely to detect unknown threats, thereby reducing risk and time to detection. Incident remediation uses in-house or in-network remediation providers plus quick detection times to reduce cost for handling the incident.

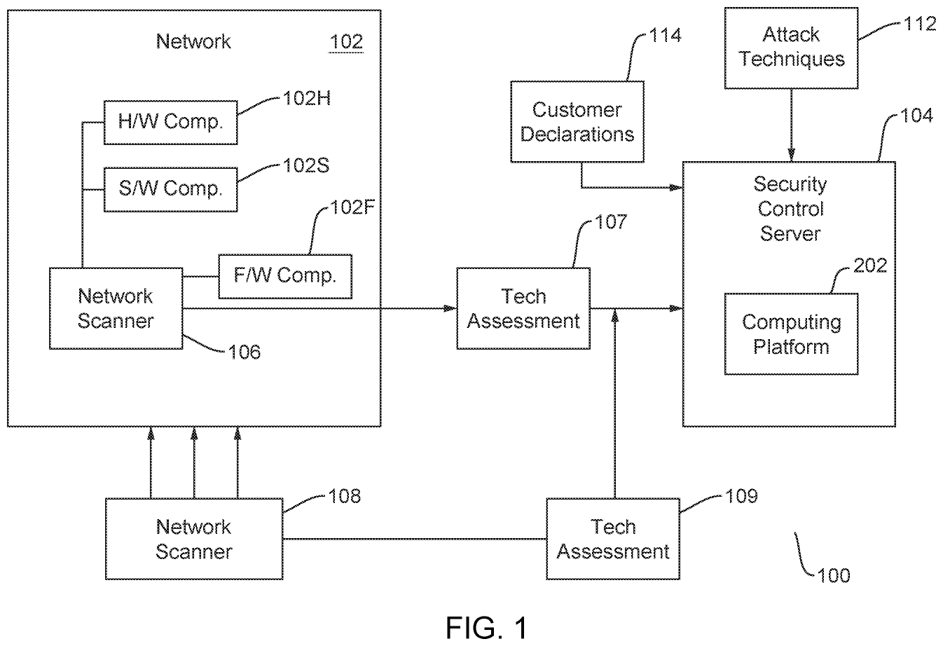

FIG. 1 depicts a system 100 to assess a network 102 with a specified configuration to determine the cybersecurity risk therein according to the disclosed embodiments. System 100 includes a security control server 104 that provides the platform to assess the cybersecurity risk within network 102 and provide risk evaluations and scores to facilitate the development of a cybersecurity insurance policy as well as means to mitigate risks. System 100 depicts the various components that may be used to execute the processes disclosed below.

Network 102 may be a customer network. It may be a commercial, private, or public network in that it may be accessed any number of ways. Preferably, network 102 has a specified configuration using hardware components 102H and software components 102S. Network 102 also may include firmware components 102F. These components comprise the unique configuration of network 102. These components also are subject to possible cybersecurity threats and attacks based on their configuration.

Security control server 104 collects information about the threats and receives real time assessments and data from network 102. The disclosed embodiments use network scanners 106 and 108 to perform technical assessments of network 102. Network scanner 106 may be on network technology that provides active defense to customers and data to security control server 104. Network scanner 106 may be placed on network 102 if the customer of the network has a cybersecurity insurance policy. Network scanner 108 may be off network technology that monitors what is exposed to the internet and the like outside network 104. Security control server 104 does not necessarily need permission from the customer of network 102. Network scanner 108 may be used to establish a price risk before the customer buys the policy because nothing has to be installed on network 102.

Attack techniques 112 may be provided to security control server 104. Attack techniques 112 are disclosed in greater detail below. Network scanners 106 and 108 may use attack techniques to expose known vulnerabilities within network 102 and provide technical assessments of how the network handles these vulnerabilities. For example, network scanner 106 may use a set of attack techniques 112 against hardware components 102H, software components 102S, and firmware components 102F to generate on-network technical assessments 107. Network scanner 108 may use a different set of attack techniques to monitor what comes off network to outside data storage. Network scanner 108 may assess whether permission is given to the outside world into network 102, which may lead to high profile attacks as network 102 is publicly accessible.

Technical assessments 107 and 109 are provided to security control server 104 to eventually determine a score for the cybersecurity risk to network 102. This process is disclosed in greater detail below. Instead of using historical data, the disclosed embodiments use live data generated using a dynamic set of threats against a specific configuration of network 102. Every network for a company is different. Thus, a “one size fits all” approach is not effective in determining the cybersecurity risk of network 102.

Examples of threat assessments generated using attack techniques from within network 102 and outside of network 102 may be given. For example, an example of off network data of interest to determining cybersecurity risk is a list of domains and sub-domains owned by the company of network 102. This data may be collected off network using network scanner 108 to automatically scans to identify existing network domains and sub-domains used by network 102. Another example of off network data may be a list of all domains and sub-domains owned by the company provided in customer declarations 114. The self-declaration of the domains and sub-domains may be submitted as part of an insurance policy application.

Using the disclosed processes, security control server 104 automatically compares domains and sub-domains provided by the customer with what was automatically detected in technical assessments 109. This analysis is important because if what the customer declared is different from what is detected by network scanner 108, then this difference may indicate that the customer does not know or are not managing all of their network that is exposed to the internet.

The disclosed embodiments also assess potential risks within network 102. Network scanner 106 may be placed on or sent to network 102 to monitory security controls as attacks are made against the specific configuration of the components within network 102. For example, a list of all user accounts with administrator privileges for a specific customer asset may be desired. Network scanner 106 is on network technology that automatically scans user directories systems to identify privilege levels. Further, it also may identify locations from which administrators log onto network 102. Network scanner 106 automatically scans user login records, filtered by those who have administrator privileges.

The technical assessments provided by these attack techniques from within network 102 may help to automatically identify where administrators log in from to determine if they are doing so from a geographically distant location from their usual spots or customer office locations. Administrator accounts have the power to cause a lot of damage if used inappropriately or by a hostile actor. An unusual login location by an administrator may identify a breach, so the disclosed embodiments may generate an alert or force a password reset.

As noted above, network scanner 106 is installed on network 102. This feature may be performed by installing software on a device within network 102 or on a network firewall to monitor traffic. Other options may include having network scanner 106 installed in the operating system or other platform within network 102. Network scanner 108 is deployed outside network 102, possibly in a cloud server or device directed to network 102. As it is outside network 102, network scanner 108 does not need permission to perform technical assessments.

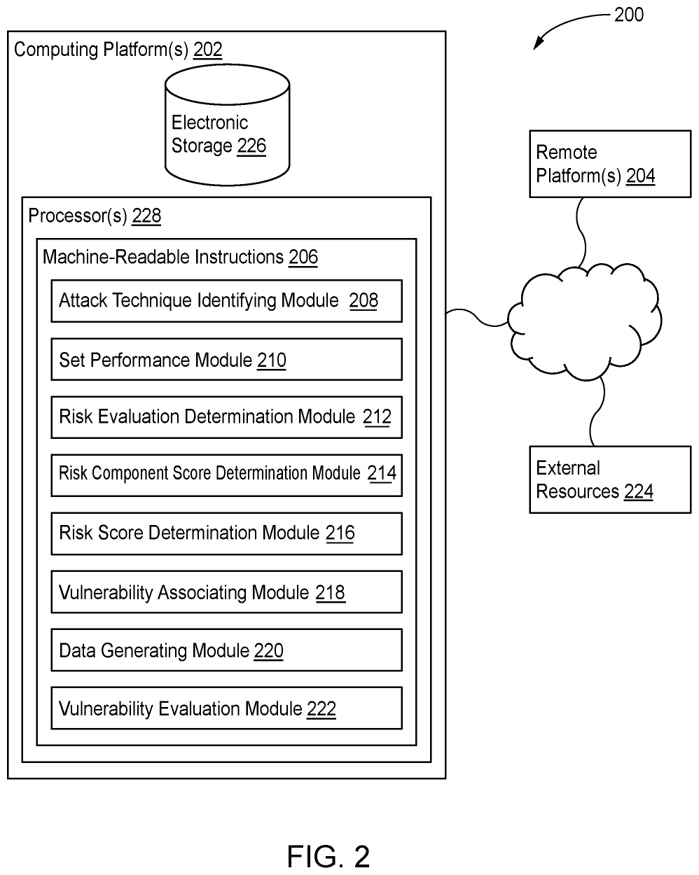

FIG. 2 illustrates a system 100 configured for assessing risk within a network 102 having a specified configuration, wherein the network includes hardware components and software components, in accordance with one or more implementations. In some implementations, system 100 may include security control server 104 having one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of attack technique identifying module 208, set performance module 210, risk evaluation determination module 212, risk component score determination module 214, risk score determination module 216, vulnerability associating module 218, data generating module 220, vulnerability evaluation module 222, and/or other instruction modules.

Attack technique identifying module 208 may be configured to identify a plurality of attack techniques 112 to target the hardware components 102H and the software components 102S of the network 102. Attack technique identifying module 208 retrieves that attack techniques from a third party source, disclosed in greater detail below. The attack techniques change over time to reflect evolving threats in cybersecurity. Firmware components 102F also may be targeted by attack techniques 112.

Set performance module 210 may be configured to perform a first set of technical assessments 107 from inside the network 102. Each technical assessment may evaluate at least one of the attack techniques as the technique internally applies to the specified configuration of the network. Network scanner 106 applies the appropriate attack techniques to the uniquely configured components within network 102. Technical assessments 107 are generated as a result.

Set performance module 210 may be configured to perform a second set of technical assessments 109 from outside the network using network scanner 108. Each technical assessment may evaluate at least one of the attack techniques as the technique externally applies to the specified configuration of the network 102. Network scanner 108 may monitor network 102 using attack techniques 112 coming from outside the network, such as from storage servers or emails.

Risk evaluation determination module 212 may be configured to determine a plurality of risk evaluations. Each risk evaluation may evaluate a defined risk to the specified configuration of the network using a corresponding technical assessment. Each risk evaluation may measure a risk of attack using the at least one attack technique evaluated by the technical assessment. The risk may correspond to the risk of the at least one attack technique being successful against the specified configuration of the network.

Risk component score determination module 214 may be configured to determine a plurality of risk component scores. Each risk component scores may correspond to a component within the network using at least one risk evaluation of the plurality of risk evaluations.

Risk score determination module 216 may be configured to determine an overall risk score using at least two risk component scores. The overall risk score may correspond to a total cyber security risk to the network. Each of the risk component scores may be weighted according to the corresponding component. These processes are disclosed in greater detail below.

Vulnerability associating module 218 may be configured to associate a known vulnerability within the specified configuration of the network with the attack technique. The known vulnerability can be exploited from inside or outside the network.

Data generating module 220 may be configured to generate live data when performing the first or the second set of technical assessments. The live data may correspond to the attack technique under evaluation.

Vulnerability evaluation module 222 may be configured to evaluate a vulnerability of the at least one attack technique inside the network to generate the live data for the first set of technical assessments. Vulnerability evaluation module 222 also may be configured to evaluate a vulnerability the at least one attack technique outside the network to generate the live data for the second set of technical assessments.

In some implementations, computing platform(s) 202, remote platform(s) 204, and/or external resources 224 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 224 may be operatively linked via some other communication media.

A given remote platform 204 may include one or more processors configured to execute computer program modules. The computer program modules may be configured to enable an expert or user associated with the given remote platform 204 to interface with system 200 and/or external resources 224, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 224 may include sources of information outside of system 200, external entities participating with system 200, and/or other resources. In some implementations, some or all of the functionality attributed herein to external resources 224 may be provided by resources included in system 200.

Computing platform(s) 202 may include electronic storage 226, one or more processors 228, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 226 may comprise non-transitory storage media that electronically stores information. The electronic storage media of electronic storage 226 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 226 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 226 may include one or more virtual storage resources (e.g., cloud storage, a virtual private network, and/or other virtual storage resources). Electronic storage 226 may store software algorithms, information determined by processor(s) 228, information received from computing platform(s) 202, information received from remote platform(s) 204, and/or other information that enables computing platform(s) 202 to function as described herein.

Processor(s) 228 may be configured to provide information processing capabilities in computing platform(s) 202. As such, processor(s) 228 may include one or more of a digital processor, an analog processor, a digital circuit designed to process information, an analog circuit designed to process information, a state machine, and/or other mechanisms for electronically processing information. Although processor(s) 228 is shown in FIG. 2 as a single entity, this is for illustrative purposes only. In some implementations, processor(s) 228 may include a plurality of processing units. These processing units may be physically located within the same device, or processor(s) 228 may represent processing functionality of a plurality of devices operating in coordination. Processor(s) 228 may be configured to execute modules 208, 210, 212, 214, 216, 218, 220, and/or 222, and/or other modules. Processor(s) 228 may be configured to execute modules 208, 210, 212, 214, 216, 218, 220, and/or 222, and/or other modules by software; hardware; firmware; some combination of software, hardware, and/or firmware; and/or other mechanisms for configuring processing capabilities on processor(s) 228. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, and/or 222 are illustrated in FIG. 2 as being implemented within a single processing unit, in implementations in which processor(s) 228 includes multiple processing units, one or more of modules 208, 210, 212, 214, 216, 218, 220, and/or 222 may be implemented remotely from the other modules. The description of the functionality provided by the different modules 208, 210, 212, 214, 216, 218, 220, and/or 222 described below is for illustrative purposes, and is not intended to be limiting, as any of modules 208, 210, 212, 214, 216, 218, 220, and/or 222 may provide more or less functionality than is described. For example, one or more of modules 208, 210, 212, 214, 216, 218, 220, and/or 222 may be eliminated, and some or all of its functionality may be provided by other ones of modules 208, 210, 212, 214, 216, 218, 220, and/or 222. As another example, processor(s) 228 may be configured to execute one or more additional modules that may perform some or all of the functionality attributed below to one of modules 208, 210, 212, 214, 216, 218, 220, and/or 222.

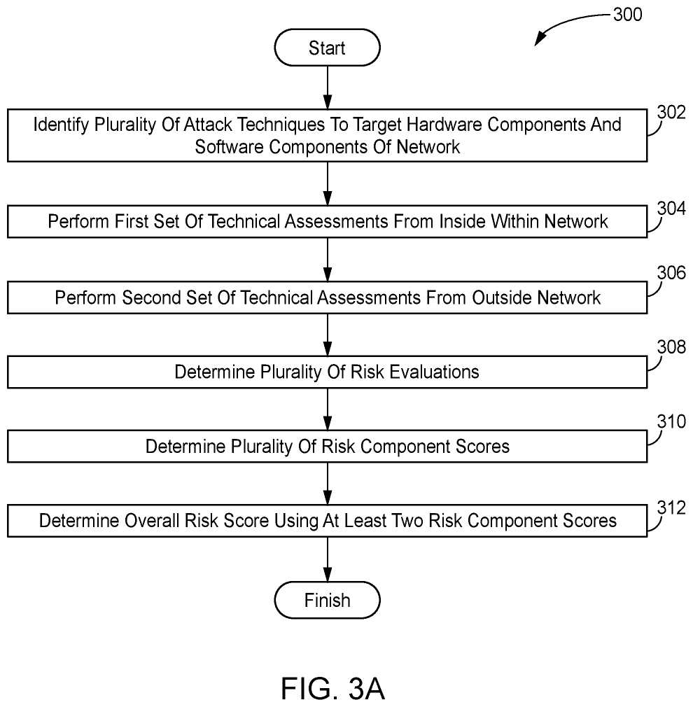

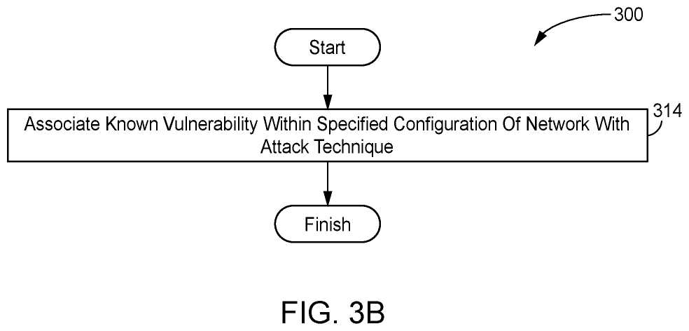

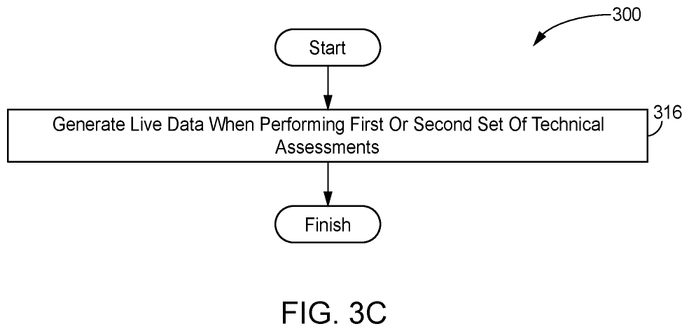

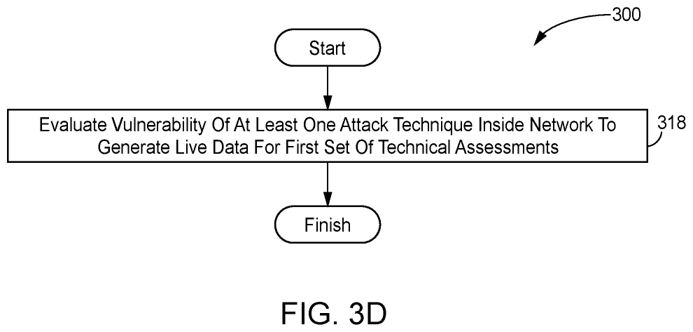

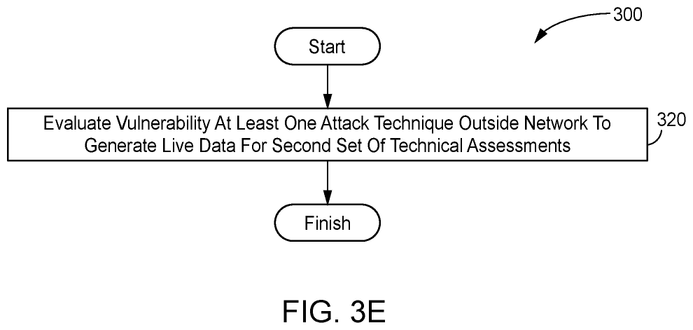

FIGS. 3A, 3B, 3C, 3D, and/or 3E illustrates a method 300 for assessing risk within a network having a specified configuration, wherein the network includes hardware components and software components, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIGS. 3A, 3B, 3C, 3D, and/or 3E and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

FIG. 3A illustrates method 300, in accordance with one or more implementations.

An operation 302 may include identifying a plurality of attack techniques to target the hardware components and the software components of the network. Operation 302 may be performed by one or more hardware processors configured by machine-readable instructions including a module that is the same as or similar to attack technique identifying module 208, in accordance with one or more implementations.

An operation 304 may include performing a first set of technical assessments from inside within the network. Each technical assessment may evaluate at least one of the attack techniques as the technique internally applies to the specified configuration of the network. Operation 304 may be performed by one or more hardware processors configured by machine-readable instructions including a module that is the same as or similar to set performance module 210, in accordance with one or more implementations.

An operation 306 may include performing a second set of technical assessments from outside the network. Each technical assessment may evaluate at least one of the attack techniques as the technique externally applies to the specified configuration of the network. Operation 306 may be performed by one or more hardware processors configured by machine-readable instructions including a module that is the same as or similar to set performance module 210, in accordance with one or more implementations.

An operation 308 may include determining a plurality of risk evaluations. Each risk evaluation may evaluate a defined risk to the specified configuration of the network using a corresponding technical assessment. Operation 308 may be performed by one or more hardware processors configured by machine-readable instructions including a module that is the same as or similar to risk evaluation determination module 212, in accordance with one or more implementations.

An operation 310 may include determining a plurality of risk component scores. Each risk component scores may correspond to a component within the network using at least one risk evaluation of the plurality of risk evaluations. Operation 310 may be performed by one or more hardware processors configured by machine-readable instructions including a module that is the same as or similar to risk component score determination module 214, in accordance with one or more implementations.

An operation 312 may include determining an overall risk score using at least two risk component scores. Each of the risk component scores may be weighted according to the corresponding component. Operation 312 may be performed by one or more hardware processors configured by machine-readable instructions including a module that is the same as or similar to risk score determination module 216, in accordance with one or more implementations.

FIG. 3B illustrates method 300, in accordance with one or more implementations.

An operation 314 may include further including associating a known vulnerability within the specified configuration of the network with the attack technique. Operation 314 may be performed by one or more hardware processors configured by machine-readable instructions including a module that is the same as or similar to vulnerability associating module 218, in accordance with one or more implementations.

FIG. 3C illustrates method 300, in accordance with one or more implementations.

An operation 316 may include further including generating live data when performing the first or the second set of technical assessments. The live data may correspond to the attack technique under evaluation. Operation 316 may be performed by one or more hardware processors configured by machine-readable instructions including a module that is the same as or similar to data generating module 220, in accordance with one or more implementations.

FIG. 3D illustrates method 300, in accordance with one or more implementations.

An operation 318 may include further including evaluating a vulnerability of the at least one attack technique inside the network to generate the live data for the first set of technical assessments. Operation 318 may be performed by one or more hardware processors configured by machine-readable instructions including a module that is the same as or similar to vulnerability evaluation module 222, in accordance with one or more implementations.

FIG. 3E illustrates method 300, in accordance with one or more implementations.

An operation 320 may include further including evaluating a vulnerability the at least one attack technique outside the network to generate the live data for the second set of technical assessments. Operation 320 may be performed by one or more hardware processors configured by machine-readable instructions including a module that is the same as or similar to vulnerability evaluation module 222, in accordance with one or more implementations.

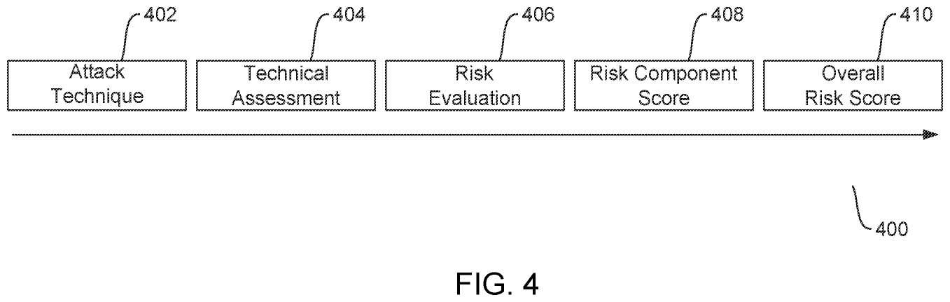

Referring to FIGS. 4-8, the processes disclosed by FIGS. 3A-E are disclosed in greater detail. FIG. 4 depicts an overview of the data flow within system 100 to generate an overall risk score 410 for network 104. The disclosed processes combine multiple steps to achieve an overall risk score 410. The steps may relate to the operations disclosed above.

Attack technique 402 may be one or more attack techniques 112. An attack technique is a known vulnerability that may be exploited by attackers. Attack techniques may by specified by a third party such that different techniques are updated continuously to reflect changes in technology. For example, known attack techniques may exist within the MITRE Att&ck Framework which lists 100s of vulnerabilities for cybersecurity technologies. Security control server 104 may determine which vulnerabilities are relevant based on the configuration of network 102. Thus, the disclosed risk assessment is based on established, documented, and measurable factors.

Technical assessment 404 is a technical assessment of the vulnerability of network 102 to exploitation using attack technique 402 as performed by technology controlled by security control server 104. FIG. 1 shows network scanners 106 and 108. Depending on where the attack technique is to be implemented, the network scanner collects the data for technical assessment 404. Technical assessment 404 is specific to the technology or configuration of network 102. For example, the disclosed embodiments would select an assessment based on whether the customer uses AWS, GCP, Azure, or On Prem technologies.

The disclosed embodiments may use specific technical assessment tools to analyze the attack techniques. One tool may cover multiple vulnerabilities. Security control server 104 may decide what components to apply the tools, such as hardware components 102H, software components 102S, and firmware components 102F. Each tool corresponds to different types of risks. The data for technical assessment 404 may be the output of these tools.

The disclosed embodiments use the results of technical assessment 404 to generate risk evaluation 408. Risk evaluation 408 is the risk of an attack using the relevant attack technique 402 being successful on network 102. Using the data analyzed for technical assessment 404, a probability may be determined that a breach may occur from inside or outside network 102.

Each risk evaluation 406 contributes a risk component score 408. Risk components are subcategories of the overall risk score that group together multiple related risk evaluations 406 to give a picture of the threat for a specific vulnerability area. Overall risk score 410 is a single measure that represents the total cybersecurity risk to network 102.

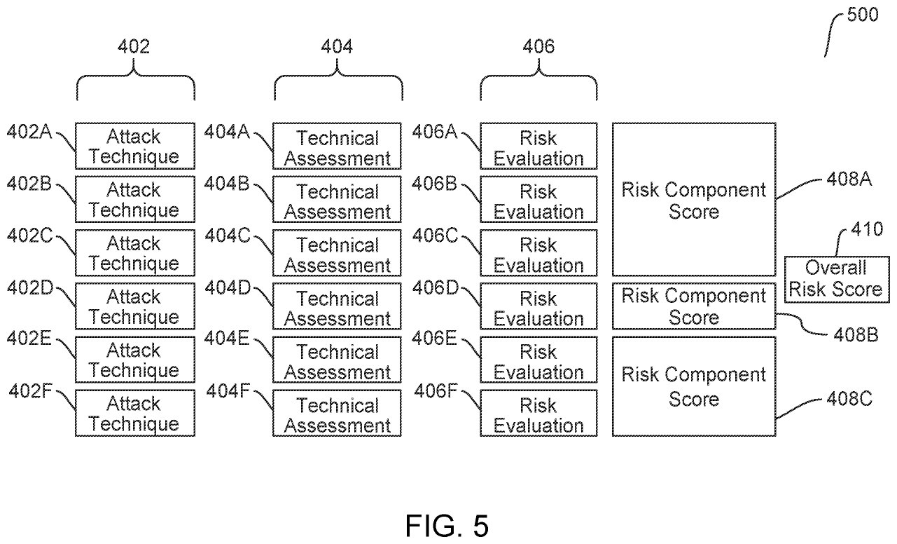

FIG. 5 depicts a flow diagram 600 showing a combination of risk evaluations 406 to generate overall risk score 410 according to the disclosed embodiments. The process disclosed in FIG. 4 may be repeated across multiple attack techniques 402. The resulting risk evaluations 406 may be combined to generate risk component scores 408. For example, security control server 104 may implement attack techniques 402A, 402B, and 402C using network scanner 106 within network 102 and attack techniques 402D, 402E, and 402F using network scanner 108. The attack techniques used may be selected from attack techniques 112 provided to security control server 104.

Each attack technique 402 address a potential vulnerability in network 102. For example, attack technique 402A may test a vulnerability in hardware components 102H. Attack technique 402B may test a vulnerability in software components 102S. Attack technique 402C may test a vulnerability in firmware components 102F. Implementation of the attack techniques produces live data to be used in the applicable technical assessments 404, shown as technical assessment 107 in FIG. 1.

Attack techniques 402D, 402E, and 402F are implemented outside network 102. Each technique may address a vulnerability from a separate data storage address within system 100. The data generated from each attack technique is used by the associated technical assessment, shown as technical assessment 109 in FIG. 1. As shown in FIG. 5, each technical assessment 404A, 404B, 404C, 404D, 404E, and 404F is performed to assess the vulnerability of network 102 to its corresponding attack technique. Attack technique 402D may pertain to a specific, high risk vulnerability of importance to cybersecurity risk.

Each technical assessment 404 provides results to generate a corresponding risk evaluation 406. Thus, risk evaluation 406A represents the risk of an attack using attack from within network 102 using technique 402A against hardware components 102H being successful. Risk evaluation 406B represents the risk of an attack from within network 102 using attack technique 402B against software components 102S being successful. Risk evaluation 406C represents the risk of an attack also within network 102 using attack technique 402C against firmware components 102F being successful.

Risk evaluations 406D, 406E, and 406F relate to attack techniques 402D, 402E, and 402F, respectively, of the risk of being attacked successfully from outside network 102. As disclosed above, tools may be used to implement these attack techniques. Risk evaluation 406D may be of particular interest to the risk of a cybersecurity attack.

If flow diagram 500, risk component scores 408 to not match individually with each risk evaluation 406. Instead, multiple risk evaluations 406 may be combined into a single risk component score 408. For example, risk component score 408A may combine risk evaluations 406A, 406B, and 406C. Using the above example, risk component score 408A may reflect the risk inside network 102 from the appropriate attack techniques. Risk component score 408B may be based on a single risk evaluation 406D. This relationship may show the importance of the vulnerability exposed by attack technique 402D to the overall risk in network 102. Risk component score 408C may combine risk evaluations 406E and 406F to reflect the remaining risks from outside network 102.

Risk component scores 408A, 408B, and 408C are combined to generate overall risk score 410. In some embodiments, the risk component scores are weighted to generate a more accurate overall risk score. For example, risk component score 408A combines the potential risk to attacks from within network 102 using attack techniques 402A, 402B, and 402C. Network 102 may weigh this score higher if such attacks could seriously compromise the security. In other embodiments, the combination of the risk evaluations 406 are the weights and each risk component score 408 is treated equally.

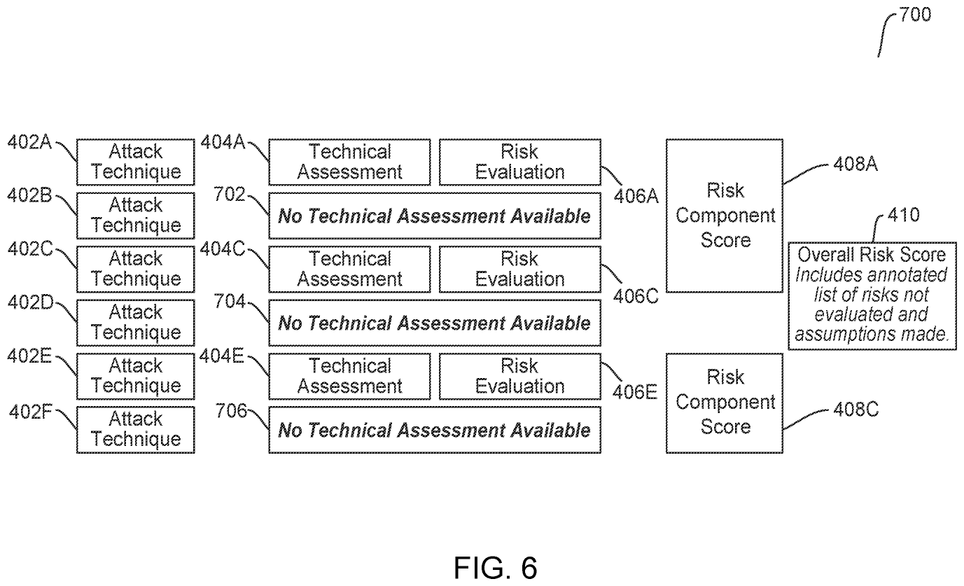

FIG. 6 depicts flow diagram 700 for risk scoring for risks not evaluated according to the disclosed embodiments. The features of flow diagram 700 similar to flow diagram 500 are not repeated and still may act the same as disclosed above. Sometimes, security control server 104 may not be able to assess every risk, particularly initially, so wherever a known risk is not assessed or an assumption is made, then this fact will be transparently compiled as part of overall risk score 410.

In FIG. 6, attack techniques 402B, 402D, and 402F may be used even though no technical assessment is available. For example, a tool for each of these attack techniques to capture the live data needed for the technical assessment may not be available. The data and information generated by attack techniques 402B, 402D, and 402F is not used. Instead, no technical assessment available indicators 702, 704, and 706 are used to alert security control server 102 to not use any information from the associated attack techniques. Overall risk score 410 is still generated using risk component scores 408A and 408C with an annotated list of risks not evaluated and assumptions made.

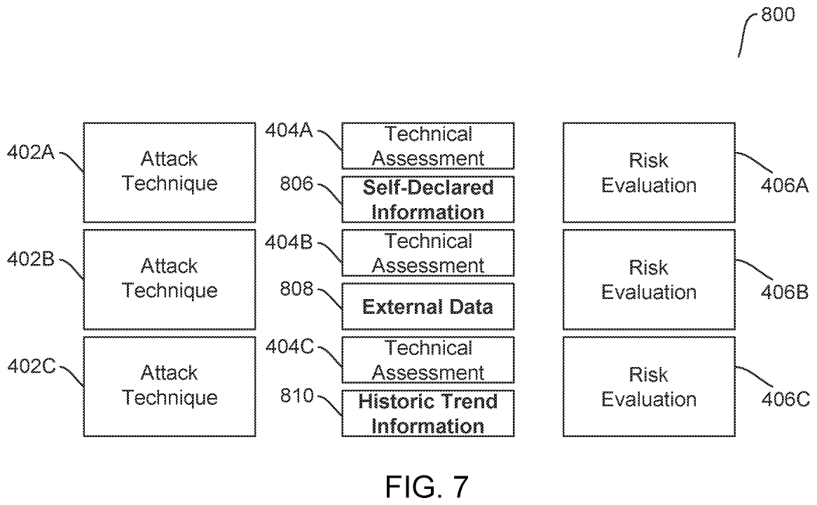

FIG. 7 depicts a flow diagram 800 of using additional sources of information for risk evaluation according to the disclosed embodiments. As shown in FIG. 1, customer declarations 114 may be provided to security control server 104 for use in risk analysis. Referring to FIG. 7, attack technique 402A generates live data for technical assessment 404A but also is supplemented by self-declared information 806. Self-declared information 806 may be information provided by the customer that is combined with technical assessment 404A for risk evaluation 406A. Attack technique 402B generates live data for technical assessment 404B that is used along with external data 808 for risk evaluation 406B. Attack technique 402C generates live data for technical assessment 404C that is used along with historic trend information 810 for risk evaluation 406C. Self-declared information 806, external data 808, and historic trend information 810 may be represented in overall risk score 410.

Further, the various embodiments have several cyber capabilities that are deployed to Customers or are built in prototype and on the way to deployment:
Spear Phishing Protection—this is implemented through the use of an API and have built a customer interface to allow users to view, manage, and take action on alerts detected by a core application
Network Vulnerability Detection— A network scanner is a scanning application that runs from a cloud network infrastructure against a user web server(s). The network scanner produces results that are used to provide recommendations for cyber security improvements. Once initial evaluation is completed and recommendations have been provided to the user, the network scanner is run recurrently and generate alerts and additional network security fix recommendations. For example, network scanner results may include:
   Additional servers and subdomains that the user network that were originally unreported or unknown by the user
   Services running on the user's network server(s)
   Known vulnerabilities, including whether any published exploits exist, for services running on the user network equipment
   Information that each service exposes which may be useful to an attacker (for example service name and version).
   Additional information that we can use, such as whether the servers are running on a Content Delivery Network; what the MX records for the domain are, etc.
Dark Web Scanner— A software application that scans data dumps and forums on the open internet and the Dark Web′. The software application searches sites on the dark web that can be accessed without a log on or password. The dark web scanner application may identify:
   Occurrences of the company's name, domain, products, or employee email information in known breach.
   Passwords that have been breached and published in previous cyber attacks.
AWS S3 Vulnerability Scanner—a software application that runs for use who use AWS S3 buckets to assesses the permissions on each bucket to look for inadvertent public exposure.
   UI Flows—A software application that identifies and generates alerts for customers to see and process security threats that we have detected.
Social engineering/spear phishing—the software application identifies possible opportunities for social engineering of users.
Ransomware threats—these threats are identified by the network vulnerability scanner.

Other processes and implementations of the disclosed embodiments may use aspects disclosed above to generate an overall risk score that reflects the level of cybersecurity within a network. The overall risk score may replace historical data scores with a live data score to improve the accuracy of an insurance policy. Customers may pay the correct amount for a policy and insurers can predict with better accuracy the policy cost. Objective data may be used in a fully automated manner to initialize and monitor a network for cybersecurity risks and remediation.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for assessing risk within a network having a specified configuration, wherein the network includes hardware components and software components, the system comprising:
one or more hardware processors configured by machine-readable instructions to:
identify a plurality of attack techniques to target the hardware components and the software components of the network;
perform a first set of technical assessments from inside within the network, wherein each technical assessment evaluates at least one of the attack techniques as the technique internally applies to the specified configuration of the network;
perform a second set of technical assessments from outside the network, wherein each technical assessment evaluates at least one of the attack techniques as the technique externally applies to the specified configuration of the network;
determine a plurality of risk evaluations, wherein each risk evaluation evaluates a defined risk to the specified configuration of the network using a corresponding technical assessment;
determine a plurality of risk component scores, wherein each risk component scores corresponds to a component within the network using at least one risk evaluation of the plurality of risk evaluations; and
determine an overall risk score using at least two risk component scores, wherein each of the risk component scores is weighted according to the corresponding component.

2. The system of claim 1, wherein the one or more hardware processors are further configured by machine-readable instructions to associate a known vulnerability within the specified configuration of the network with the attack technique.

3. The system of claim 2, wherein the known vulnerability can be exploited from inside or outside the network.

4. The system of claim 1, wherein the one or more hardware processors are further configured by machine-readable instructions to generate live data when performing the first or the second set of technical assessments, wherein the live data corresponds to the attack technique under evaluation.

5. The system of claim 4, wherein the one or more hardware processors are further configured by machine-readable instructions to evaluate a vulnerability of the at least one attack technique inside the network to generate the live data for the first set of technical assessments.

6. The system of claim 4, wherein the one or more hardware processors are further configured by machine-readable instructions to evaluate a vulnerability the at least one attack technique outside the network to generate the live data for the second set of technical assessments.

7. The system of claim 1, wherein the each risk evaluation measures a risk of attack using the at least one attack technique evaluated by the technical assessment.

8. The system of claim 7, wherein the risk corresponds to the risk of the at least one attack technique being successful against the specified configuration of the network.

9. The system of claim 1, wherein the overall risk score corresponds to a total cyber security risk to the network.

10. A method for assessing risk within a network having a specified configuration, wherein the network includes hardware components and software components, the method comprising:
identifying a plurality of attack techniques to target the hardware components and the software components of the network;
performing a first set of technical assessments from inside within the network, wherein each technical assessment evaluates at least one of the attack techniques as the technique internally applies to the specified configuration of the network;
performing a second set of technical assessments from outside the network, wherein each technical assessment evaluates at least one of the attack techniques as the technique externally applies to the specified configuration of the network;
determining a plurality of risk evaluations, wherein each risk evaluation evaluates a defined risk to the specified configuration of the network using a corresponding technical assessment;
determining a plurality of risk component scores, wherein each risk component scores corresponds to a component within the network using at least one risk evaluation of the plurality of risk evaluations; and
determining an overall risk score using at least two risk component scores, wherein each of the risk component scores is weighted according to the corresponding component.

11. The method of claim 10, further comprising associating a known vulnerability within the specified configuration of the network with the attack technique.

12. The method of claim 11, wherein the known vulnerability can be exploited from inside or outside the network.

13. The method of claim 10, further comprising generating live data when performing the first or the second set of technical assessments, wherein the live data corresponds to the attack technique under evaluation.

14. The method of claim 13, further comprising evaluating a vulnerability of the at least one attack technique inside the network to generate the live data for the first set of technical assessments.

15. The method of claim 13, further comprising evaluating a vulnerability the at least one attack technique outside the network to generate the live data for the second set of technical assessments.

16. The method of claim 10, wherein the each risk evaluation measures a risk of attack using the at least one attack technique evaluated by the technical assessment.

17. The method of claim 16, wherein the risk corresponds to the risk of the at least one attack technique being successful against the specified configuration of the network.

18. The method of claim 10, wherein the overall risk score corresponds to a total cyber security risk to the network.

19. A non-transient computer-readable storage medium having instructions embodied thereon, the instructions being executable by one or more processors to perform a method for assessing risk within a network having a specified configuration, wherein the network includes hardware components and software components, the method comprising:
identifying a plurality of attack techniques to target the hardware components and the software components of the network;
performing a first set of technical assessments from inside within the network, wherein each technical assessment evaluates at least one of the attack techniques as the technique internally applies to the specified configuration of the network;
performing a second set of technical assessments from outside the network, wherein each technical assessment evaluates at least one of the attack techniques as the technique externally applies to the specified configuration of the network;
determining a plurality of risk evaluations, wherein each risk evaluation evaluates a defined risk to the specified configuration of the network using a corresponding technical assessment;
determining a plurality of risk component scores, wherein each risk component scores corresponds to a component within the network using at least one risk evaluation of the plurality of risk evaluations; and
determining an overall risk score using at least two risk component scores, wherein each of the risk component scores is weighted according to the corresponding component.

20. The computer-readable storage medium of claim 19, wherein the method further comprises associating a known vulnerability within the specified configuration of the network with the attack technique.
